(19) United States
(12) Patent Application Publication
(10) Pub. No.: US 2024/0373156 A1
(43) Pub. Date: Nov. 7, 2024

(54) Hidden Speech Face Guard

(71) Applicant: Lisa Bahe, St. Ignatius, MT (US)

(72) Inventor: Lisa Bahe, St. Ignatius, MT (US)

(21) Appl. No.: 18/650,182

(22) Filed: Apr. 30, 2024

Related U.S. Application Data
(60) Provisional application No. 63/500,016, filed on May 4, 2023.

(51) Int. Cl. H04R 1/08; H04R 1/10

(52) U.S. Cl. CPC H04R 1/083; H04R 1/1008; H04R 2201/107

(57) ABSTRACT

The lip-reading cover device is a hands-free, disposable, and breathable lip-reading cover to prevent opposing teams from reading a coach's lips. The lip-reading cover device comprises a perforated cover that is large enough to cover the entirety of a coach's lips to prevent lip-reading. The perforated cover can be attached to the coach's microphone to allow the cover to be hands-free and move out of the way with the microphone if person-to-person communication is needed. The perforated cover can also be attached to the microphone with a hinge to flip outward from the coach's face if the coach needs to talk into the microphone, as well as person-to-person communication. The perforated cover allows for the coach to breathe normally as well as reduces background noise for clearer communication.

### CROSS-REFERENCE TO RELATED APPLICATION

The present application claims priority to, and the benefit of, U.S. Provisional Application No. 63/500,016, which was filed on May 4, 2023, and is incorporated herein by reference in its entirety.

### FIELD OF THE INVENTION

The present invention relates generally to the field of lip-reading cover devices. More specifically, the present invention relates to a face-covering device to hide speech from lip readers during a sporting event. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to an improvement in lip-reading cover devices. Generally, play calling devices like microphones are commonly used by coaches in various sports like football, baseball, and the like. However, lip reading can occur by the other team to gain an advantage by knowing plays. Accordingly, coaches may hold up their own hand, clipboard, or play sheet to block their mouths as they speak into the mic calling plays. Additionally, hired videographers can zoom in on the mouth area when verbal calls are given and obtain information.

Furthermore, more often than not coaches prevent lip-reading when calling plays by holding an opaque cover, clipboard, or play sheet over their mouth. However, it would be desirable to have a device that covers a coach's mouth from lip reading that does not require the coach to use one of their hands to hold up a shield. For example, it would be desirable for the microphone to have a lip-reading cover integrated and hands-free for the coach. Further, it would also be desirable to have the lip-reading cover be disposable and also breathable for the comfort of the coach.

Accordingly, there is a need for a lip-reading cover device designed to prevent lip-reading and allow the coach's hands to be free. Further, there is a need for the lip-reading cover device to be disposable and integrated into the microphone, so it moves with the microphone. Also, there is a need for the lip-reading cover device to be perforated to allow the coach to breathe through the device. Finally, there is a need for the lip-reading cover device to reduce background noise and display a team or sponsor logo.

Therefore, there exists a long-felt need in the art for a lip-reading cover device that provides users with a means for covering a coach's lips without having to occupy one of the coach's hands. There is also a long-felt need in the art for a lip-reading cover device that features the ability to be disposable and allows for the coach to breathe through the device. Further, there is a long-felt need in the art for a lip-reading cover device that enables users to display a team or sponsor's logo. Moreover, there is a long-felt need in the art for a device that can be moved out of the way with the microphone or flipped outward to allow person to person communication. Finally, there is a long-felt need in the art for a lip-reading cover device that reduces background noise for clearer communication through the microphone.

The subject matter disclosed and claimed herein, in one embodiment thereof, comprises a lip-reading cover device. The device is a hands-free, disposable, and breathable lip-reading cover to prevent opposing teams from reading a coach's lips. The lip-reading cover device comprises a perforated cover that is large enough to cover the entirety of a coach's lips to prevent lip-reading. The perforated cover can be attached to the coach's microphone to allow the cover to be hands-free and move out of the way with the microphone if person-to-person communication is needed. The perforated cover can also be attached to the microphone with a hinge to flip outward from the coach's face if the coach needs to talk into the microphone, as well as to communicate person-to-person. The perforated cover allows for the coach to breathe normally as well as reduces background noise for clearer communication. Further, the perforated cover will allow for the addition of a team or sponsor logo on the outside of the cover.

In this manner, the lip-reading cover device of the present invention accomplishes all of the foregoing objectives and provides users with a device that prevents a coach's lips from being read during a sporting contest. For example, the lip-reading cover device uses a perforated cover to obstruct the view of a coach's lips, allows the coach to breathe normally, and minimizes background noise. Finally, the lip-reading cover device allows for a team or sponsor's logo to be seen while preventing lip-reading.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lip-reading cover device. The device is a hands-free, disposable, and breathable lip-reading cover to prevent opposing teams from reading a coach's lips. The lip-reading cover device comprises a cover component that obscures or partially obscures a coach's or other suitable user's mouth. The cover component can be any suitable shape and size as is known in the art, depending on the wants and/or needs of a user and as long as the cover component is shaped and sized to cover a user's mouth and prevent lip-reading. Generally, the cover component would be configured in a rectangular or oval shape and would tend to be wider in the middle and skinnier at the ends to reflect the shape of a user's mouth. Further, the cover component comprises a front surface, a back surface, opposing top and bottom sides, and opposing right and left sides.

In one embodiment, the cover component of the device is configured to be secured around a microphone of a headset. In this embodiment, the cover component is rectangularly shaped and comprises an inner cavity formed by the front surface, the back surface, opposing top and bottom sides, and opposing right and left sides. The cavity is sized and shaped to accept and completely encompass the microphone of the headset. Specifically, either the right or left side would have an opening, allowing access to the hollow cavity. A user would then insert the microphone from the headset into the hollow cavity, to allow the microphone to be inside the cover component and completely covered by the cover component. In another embodiment, if the cover component needs to be removed, so that the user can speak clearly into the microphone, the cover component would have an opening in the back surface to allow the microphone to be inserted into the opening and exposed. This allows a user to utilize the microphone and prevent the cover component from blocking the microphone and muffling sounds.

In one embodiment, the cover component can be attached to the arm or stem of the microphone or headset and not directly to the microphone, itself. Specifically, the cover component can be attached behind the microphone, or to the left or right of the microphone, as well. Further, in this embodiment, the cover component can be secured to the arm or stem of the headset via clips or other suitable fasteners, as described below.

In one embodiment, the cover component is attached via a snap close attachment. The snap close attachment allows the cover component to be snapped in place anywhere on the headset, left or right of the microphone, to accommodate users who do not center their microphone but wear it off to the left or right during use.

In one embodiment, the cover component is configured as a flat, rectangular, or oval shape with minimal width. Generally, the size of the cover component is a matter of choice, and any size is suitable, as long as the cover component is large enough to comfortably cover a user's mouth in its entirety to prevent lip-reading. In another embodiment, the cover component is comprised of an elongated length, which can be used when users set their microphones to the left or right of their mouth. Thus, the cover component can be one elongated shape that will point either right or left. Further, in this embodiment, the flat cover component is secured to a microphone via a pair of clips or other suitable securing fasteners. The pair of clips are attached to the back surface of the cover component and then secured around the microphone of the headset. Specifically, the clips have a c-shape with the ability to open to accept the microphone and return to the original position to hold the cover component in place. The clips would be manufactured from spring steel, clastic polymer, aluminum, or any other suitable material known in the art. Further, the clips are attached to the back surface using screws, snap features, adhesive, or any other suitable attachment method known in the art.

In one embodiment, the cover component can also comprise hinges attached to the back surface that will attach to the microphone of the headset. The hinge would have a surface that can attach to the cover component by screws, adhesive, snap features, or any other suitable attachment method known in the art. The hinge is a standard hinge with one side attached to the cover component and an opposing side attached to the microphone with a pinned joint in the center. The side of the hinge attached to the microphone can be attached with a bracket, zip ties, snap feature, or any other suitable attachment method known in the art. The hinge allows the cover component to swing away from the user's face while retaining the microphone in front of the user's mouth for use. Thus, the hinges allow the cover component to be foldable when not in use and moved out of the way. In this embodiment, the cover component can also comprise a knob with a two-way hinge positioned behind the microphone and secured to the cover component. The knob and two-way hinge allow a user to manually flip the cover component outward and away from the mouth when not in use or slide the cover component upward and out of the way of the microphone and microphone arm.

In one embodiment, the cover component comprises a plurality of perforations that allow for air to pass through. Thus, the cover component prevents lip-reading but also allows a user to breathe normally and without restriction. Typically, the cover component with the plurality of perforations would be a mesh structure with holes/perforations of suitable size and shape to obscure the mouth of the user but allow air to pass through for breathability.

In one embodiment, the cover component is disposable, so it can be discarded after each sporting event and replaced with a new one. In another embodiment, the cover component is reusable and can be washed and/or sanitized between sporting events.

In one embodiment, the cover component can be used to prevent background noise from reaching the microphone and allow for clearer communication through the microphone.

In one embodiment, the cover component comprises a team or sponsor logo affixed to the front surface, or any other suitable design, logo, graphic, etc., as is known in the art. The team or sponsor logo can be painted, decal, or sticker, printed into the mesh, or any other suitable method as known in the art. Further, the cover component can be designed to be any suitable color, pattern, stripes, etc., as is known in the art.

In one embodiment, the lip-reading cover device would be manufactured from a lightweight, durable material such as plastic, fiberglass, or the like and manufactured through common extruding and molding processes. Specifically, the device can be manufactured from heat-scalable plastic or polymers, such as polypropylene, acrylonitrile-butadiene-styrene (ABS), polyethylene, polyethylene terephthalate, polyvinyl chloride, polystyrene, etc., or any other suitable material as is known in the art, such as, but not limited to, acrylic, polycarbonate, aluminum, or stainless steel. Generally, the device is also manufactured from a material that is water-resistant or waterproof, or the cover component comprises a coating that is water-resistant or waterproof. Furthermore, the device is manufactured from a material that is antibacterial or antimicrobial or the cover component comprises a coating that is antibacterial or antimicrobial.

In yet another embodiment, the lip-reading cover device comprises a plurality of indicia.

In yet another embodiment, a method of blocking a user's mouth to prevent lip reading during a sporting event is disclosed. The method includes the steps of providing a lip-reading cover device comprising a perforated cover that covers the lips of a coach to prevent lip-reading. The method also comprises applying the lip-reading cover device to a microphone of a coach's headset. Further, the method comprises positioning the microphone with the lip-reading cover device in front of the coach's lips. Also, the method comprises allowing the lip-reading cover device to move with the microphone to stay in position hands-free. Finally, the method comprises moving the lip-reading cover device out of the way, when the coach requires face-to-face communication.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-D illustrate a perspective view of one embodiment of the lip-reading cover device of the present invention showing the perforated cover as a sleeve over the microphone in accordance with the disclosed architecture;

FIGS. 2A-C illustrate a perspective view of one embodiment of the lip-reading cover device of the present invention showing how clips hold the perforated cover on the microphone in accordance with the disclosed architecture;

FIGS. 3A-B illustrate a perspective view of one embodiment of the lip-reading cover device of the present invention showing hinges allowing the perforated cover to pivot in accordance with the disclosed architecture;

FIG. 4 illustrates a perspective view of one embodiment of the lip-reading cover device of the present invention showing the perforated cover of the device in accordance with the disclosed architecture;

FIGS. 5A-B illustrate a perspective view of one embodiment of the lip-reading cover device of the present invention in use in accordance with the disclosed architecture; and

FIG. 6 illustrates a flowchart showing the method of blocking a user's mouth to prevent lip reading during a sporting event in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a lip-reading cover device that provides users with a means for covering a coach's lips without having to occupy one of the coach's hands. There is also a long-felt need in the art for a lip-reading cover device that features the ability to be disposable and allows for the coach to breathe through the device. Further, there is a long-felt need in the art for a lip-reading cover device that enables users to display a team or sponsor's logo. Moreover, there is a long-felt need in the art for a device that can be moved out of the way with the microphone or flipped outward, to allow person to person communication. Finally, there is a long-felt need in the art for a lip-reading cover device that reduces background noise for clearer communication through the microphone.

The present invention, in one exemplary embodiment, is a novel lip-reading cover device. The device is a hands-free, disposable, and breathable lip-reading cover to prevent opposing teams from reading a coach's lips. The lip-reading cover device comprises a perforated cover that is large enough to cover the entirety of a coach's lips to prevent lip-reading. The perforated cover can be attached to the coach's microphone to allow the cover to be hands-free and move out of the way with the microphone if person-to-person communication is needed. The present invention also includes a novel method of blocking a user's mouth to prevent lip reading during a sporting event. The method includes the steps of providing a lip-reading cover device comprising a perforated cover that covers the lips of a coach to prevent lip-reading. The method also comprises applying the lip-reading cover device to a microphone of a coach's headset. Further, the method comprises positioning the microphone with the lip-reading cover device in front of the coach's lips. Also, the method comprises allowing the lip-reading cover device to move with the microphone to stay in position hands-free. Finally, the method comprises moving the lip-reading cover device out of the way, when the coach requires face-to-face communication.

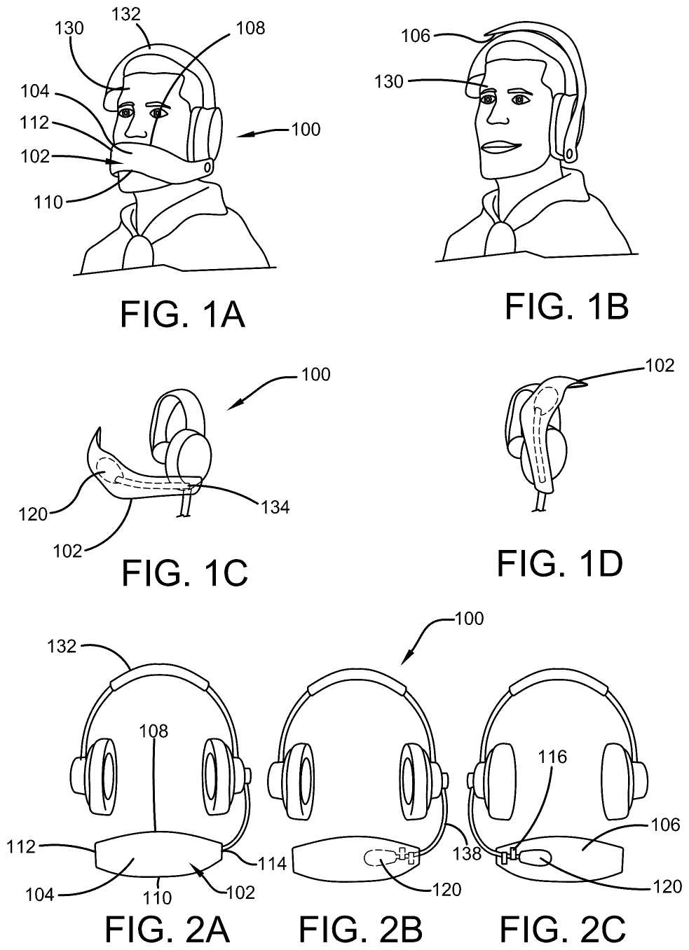

Referring initially to the drawing, FIGS. 1A-D illustrates a view of one embodiment of the lip-reading cover device 100 that is a hands-free, disposable, and breathable lip-reading cover to prevent opposing teams from reading a coach's lips. The device 100 can also be used by commentators, players, offensive/defensive coordinators, etc., or anyone who wishes to obscure their lips while talking. The lip-reading cover device 100 comprises a cover component 102 that obscures or partially obscures a coach's or other suitable user's mouth 128. The cover component 102 can be any suitable shape and size as is known in the art, depending on the wants and/or needs of a user 130 and as long as the cover component 102 is shaped and sized to cover a user's mouth 128 and prevent lip-reading. Generally, the cover component 102 would be configured in a rectangular or oval shape and would tend to be wider in the middle and skinnier at the ends to reflect the shape of a user's mouth 128. Further, the cover component 102 comprises a front surface 104, a back surface 106, opposing top and bottom sides 108 and 110, and opposing left and right sides 112 and 114, respectively.

Furthermore, in one embodiment, the cover component 102 of the device 100 is configured to be secured around a microphone 120 of a headset 132 like a sleeve. In this embodiment, the cover component 102 is rectangularly shaped and comprises an inner cavity 124 formed by the front surface 104, the back surface 106, opposing top 108 and bottom 110 sides, and opposing left 112 and right 114 sides. The cavity 124 is sized and shaped to accept and completely encompass the microphone 120 of the headset 132. Specifically, either the right 114 or left 112 side would have an opening 134, allowing access to the hollow cavity 124. A user 130 would then insert the microphone 120 from the headset 132 into the hollow cavity 124, to allow the microphone 120 to be inside the cover component 102 and completely covered by the cover component 102. Furthermore, as not all users 130 position the microphone 120 directly in front of their mouth, but some users position the microphone 120 off center to one side or the other, the cover component 102 is large enough (i.e., has increased length and/or width as needed), to still cover a user's mouth even if the microphone 120 is positioned to one side or the other.

Additionally, if the cover component 102 needs to be removed, so that the user 130 can speak clearly into the microphone 120, the cover component 102 would have an opening 136 in the back surface 106 to allow the microphone 120 to be inserted into and through the opening 136. This exposes the microphone 120 to the outside air and removes the microphone 120 from the cover component 102, without removing the cover component 102 from the microphone arm 138. Thus, this allows a user 130 to utilize the microphone 120 and prevent the cover component 102 from blocking the microphone 120 and muffling sounds.

In one embodiment, the cover component 102 can be attached to the arm or stem 121 of the microphone 120 or headset and not directly to the microphone 120, itself. Specifically, the cover component 102 can be attached behind the microphone 120, or to the left or right of the microphone 120, as well. Further, in this embodiment, the cover component 102 can be secured to the arm or stem 121 of the headset 1321 via clips 116 or other suitable fasteners, as described below.

In another embodiment, the cover component 102 is attached via a snap close attachment 123. The snap close attachment 123 allows the cover component 102 to be snapped in place anywhere on the headset 132, left or right of the microphone 120, to accommodate users who do not center their microphone 120 but wear it off to the left or right during use.

As shown in FIGS. 2A-C, in another embodiment, the cover component 102 is configured as a flat, rectangular, or oval shape with minimal width. Generally, the size of the cover component 102 is a matter of choice, and any size is suitable, as long as the cover component 102 is large enough to comfortably cover a user's mouth 128 in its entirety to prevent lip-reading. In another embodiment, the cover component 102 is comprised of an elongated length, which can be used when users set their microphones 120 to the left or right of their mouth. Thus, the cover component 102 can be one elongated shape that will point either right or left.

Further, in this embodiment, the flat cover component 102 is secured to a microphone 120 via a pair of clips 116 or other suitable securing fasteners. The pair of clips 116 are attached to the back surface 106 of the cover component 102 and then secured around the microphone 120 and/or the microphone arm 138 of the headset 132. Specifically, the clips 116 have a c-shape with the ability to open to accept the microphone 120 and/or the microphone arm 138 and return it to the original position to hold the cover component 102 in place. The clips 116 would be manufactured from spring steel, elastic polymer, aluminum, or any other suitable material known in the art. Further, the clips 116 are attached to the back surface 106 using screws, snap features, adhesive, or any other suitable attachment method known in the art.

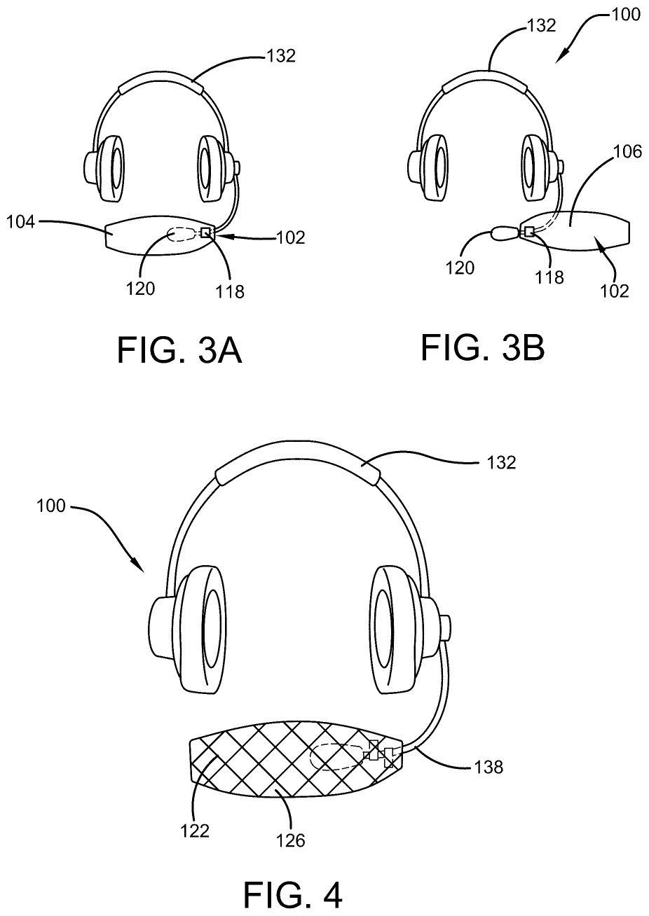

As shown in FIGS. 3A-B, in one embodiment, the cover component 102 can also comprise hinges 118 attached to the back surface 106 that will attach to the microphone 120 and/or microphone arm 138 of the headset 132. The hinge 118 would have a surface that can attach to the cover component 102 by screws, adhesive, snap features, or any other suitable attachment method known in the art. The hinge 118 is a standard hinge with one side attached to the cover component 102 and an opposing side attached to the microphone 120 and/or microphone arm 138 with a pinned joint in the center. The side of the hinge 118 attached to the microphone 120 and/or microphone arm 138 can be attached with a bracket, zip ties, snap feature, or any other suitable attachment method known in the art. The hinge 118 allows the cover component 102 to swing away from the user's face 140 while retaining the microphone 120 in front of the user's mouth 128 for use. Thus, the hinges 118 allow the cover component 102 to be foldable when not in use and moved out of the way.

Additionally, in another embodiment, the cover component 102 can also comprise a knob 142 with a two-way hinge 144 positioned behind the microphone 120 and secured to the cover component 102. The knob 142 and two-way hinge 144 allows a user 130 to manually flip the cover component 102 outward and away from the mouth 128 when not in use or slide the cover component 102 upward and out of the way of the microphone 120 and microphone arm 138.

As shown in FIG. 4, the cover component 102 comprises a plurality of perforations 126 that allow for air to pass through. Thus, the cover component 102 prevents lip-reading but also allows a user 130 to breathe normally and without restriction. Typically, the cover component 102 with the plurality of perforations 126 would be configured in a mesh structure 122. Further, the plurality of holes/perforations 126 would be of suitable size and shape to obscure the mouth 128 of the user 130 but also allow air to pass through for breathability. Specifically, the perforations 126 of the mesh structure 122 comprise openings that are circular, diamond-shaped, square, or any other suitable shape known in the art. Typically, the mesh structure 122 is a lattice of material that crosses one another in a small enough pattern to obscure the view of the user's mouth 128 but also allows air to pass through.

Furthermore, in one embodiment, the cover component 102 is disposable, so it can be discarded after each sporting event and replaced with a new one. In another embodiment, the cover component 102 is reusable and can be washed and/or sanitized between sporting events.

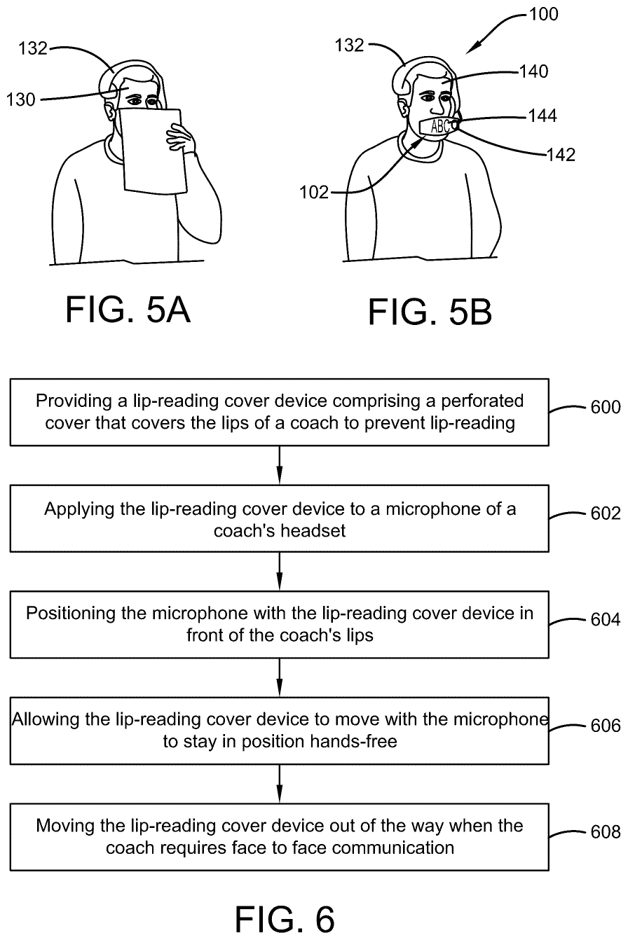

As shown in FIGS. 5A-B, in operation, the lip-reading cover device 100 is a hands-free, disposable, and breathable lip-reading cover to prevent opposing teams from reading a user's lips. The lip-reading cover device 100 comprises a cover component 102 that obscures a user's mouth 128 during use. Additionally, the cover component 102 can be used to prevent background noise from reaching the microphone 120 and allows for clearer communication through the microphone 120.

Furthermore, the cover component 102 comprises a team or sponsor logo 142 affixed to the front surface 104, or any other suitable design, logo, graphic, etc., as is known in the art. The team or sponsor logo 142 can be painted, decal, or sticker, printed into the mesh structure 122, or any other suitable method as known in the art. Further, the cover component 102 can be designed to be any suitable color, pattern, stripes, etc., as is known in the art.

Additionally, the lip-reading cover device 100 would be manufactured from a lightweight, durable material such as plastic, fiberglass, or the like and manufactured through common extruding and molding processes. Specifically, the device 100 can be manufactured from heat-scalable plastic or polymers, such as polypropylene, acrylonitrile-butadiene-styrene (ABS), polyethylene, polyethylene terephthalate, polyvinyl chloride, polystyrene, etc., or any other suitable material as is known in the art, such as, but not limited to, acrylic, polycarbonate, aluminum, or stainless steel. Generally, the device 100 is also manufactured from a material that is water-resistant or waterproof, or the cover component 102 comprises a coating that is water-resistant or waterproof. Furthermore, the device 100 is manufactured from a material that is antibacterial or antimicrobial or the cover component 102 comprises a coating that is antibacterial or antimicrobial.

In yet another embodiment, the lip-reading cover device 100 comprises a plurality of indicia 144. The cover component 102 of the device 100 may include advertising, a trademark, or other letters, designs, or characters, printed, painted, stamped, or integrated into the cover component 102, or any other indicia 144 as is known in the art. Specifically, any suitable indicia 144 as is known in the art can be included, such as, but not limited to, patterns, logos, emblems, images, symbols, designs, letters, words, characters, animals, advertisements, brands, etc., that may or may not be microphone, headset, or brand related.

FIG. 6 illustrates a flowchart of the method of blocking a user's mouth to prevent lip reading during a sporting event. The method includes the steps of at 600, providing a lip-reading cover device comprising a perforated cover that covers the lips of a coach to prevent lip-reading. The method also comprises at 602, applying the lip-reading cover device to a microphone of a coach's headset. Further, the method comprises at 604, positioning the microphone with the lip-reading cover device in front of the coach's lips. Also, the method comprises at 606, allowing the lip-reading cover device to move with the microphone to stay in position hands-free. Finally, the method comprises at 608, moving the lip-reading cover device out of the way, when the coach requires face-to-face communication.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “lip-reading cover device”, “cover device”, “lip-reading device”, and “device” are interchangeable and refer to the lip-reading cover device 100 of the present invention.

Notwithstanding the foregoing, the lip-reading cover device 100 of the present invention can be of any suitable size and configuration as is known in the art without affecting the overall concept of the invention, provided that it accomplishes the above-stated objectives. One of ordinary skill in the art will appreciate that the lip-reading cover device 100 as shown in FIGS. 1-6 is for illustrative purposes only, and that many other sizes and shapes of the lip-reading cover device 100 are well within the scope of the present disclosure. Although the dimensions of the lip-reading cover device 100 are important design parameters for user convenience, the lip-reading cover device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. cm What is claimed is:

1. A lip-reading cover device that prevents opposing teams from reading a coach's lips, the lip-reading cover device comprising:
a cover component;
wherein the cover component obscures or partially obscures a user's mouth preventing lip-reading;
wherein the cover component is secured to a microphone of a headset; and
further wherein a user can speak clearly into the microphone without the cover component blocking the sound.

2. The lip-reading cover device of claim 1, wherein the cover component is configured in a rectangular shape with a front surface, a back surface, opposing top and bottom sides and, and opposing left and right sides.

3. The lip-reading cover device of claim 2, wherein the cover component comprises an inner cavity, and the cover component is configured to be secured around the microphone of the headset like a sleeve.

4. The lip-reading cover device of claim 3, wherein the cover component comprises an opening in the back surface, which exposes the microphone and removes the microphone from the cover component, without removing the cover component from around a microphone arm.

5. The lip-reading cover device of claim 2, wherein the cover component is configured as a flat, rectangular or oval shape with minimal width.

6. The lip-reading cover device of claim 5, wherein the cover component is secured to the microphone via a pair of clips attached to the back surface of the cover component and then secured around the microphone.

7. The lip-reading cover device of claim 6, wherein the cover component also comprise hinges attached to the back surface that will attach to the microphone and will allow the cover component to swing away from a user's face, while retaining the microphone in front of a user's mouth for use.

8. The lip-reading cover device of claim 7, wherein the cover component comprises a knob with a two-way hinge positioned behind the microphone and secured to the cover component, which allows a user to manually flip the cover component outward and away from the mouth when not in use or slide the cover component upward and out of way of the microphone.

9. The lip-reading cover device of claim 8, wherein the cover component comprises a plurality of perforations that allow for air to pass through.

10. The lip-reading cover device of claim 9, wherein the cover component with the plurality of perforations would be configured in a mesh structure.

11. The lip-reading cover device of claim 1, wherein the cover component is disposable.

12. The lip-reading cover device of claim 1, wherein the cover component is reusable.

13. The lip-reading cover device of claim 1, wherein the cover component comprises a team or sponsor logo affixed to the front surface.

14. A lip-reading cover device that prevents opposing teams from reading a coach's lips, the lip-reading cover device comprising:
a cover component is configured in a flat, rectangular or oval shape with minimal width and a front surface, a back surface, opposing top and bottom sides and, and opposing left and right sides;
wherein the cover component obscures or partially obscures a user's mouth preventing lip-reading;
wherein the cover component is secured to a microphone via a pair of clips attached to the back surface of the cover component and then secured around the microphone of a headset;
wherein the cover component also comprise hinges attached to the back surface that will attach to the microphone and will allow the cover component to swing away from a user's face, while retaining the microphone in front of a user's mouth for use;
wherein the cover component comprises a plurality of perforations that allow for air to pass through;
wherein the cover component with the plurality of perforations would be configured in a mesh structure; and
further wherein a user can speak clearly into the microphone without the cover component blocking the sound.

15. The lip-reading cover device of claim 14, wherein the cover component is secured to an arm of the microphone.

16. The lip-reading cover device of claim 14, wherein the cover component is secured to the headset via a snap close attachment.

17. The lip-reading cover device of claim 14, wherein the cover component comprises an elongated length to cover microphones that are offset to a right or left of a user's mouth.

18. The lip-reading cover device of claim 14, wherein the cover component comprises a coating that is water-resistant or waterproof and that is antibacterial or antimicrobial.

19. The lip-reading cover device of claim 14 further comprising a plurality of indicia.

20. A method of blocking a user's mouth to prevent lip reading during a sporting event, the method comprising the following steps:
providing a lip-reading cover device comprising a perforated cover that covers the lips of a coach to prevent lip-reading;
applying the lip-reading cover device to a microphone of a coach's headset;
positioning the microphone with the lip-reading cover device in front of the coach's lips;
allowing the lip-reading cover device to move with the microphone to stay in position hands-free; and
moving the lip-reading cover device out of the way, when the coach requires face-to-face communication.
